(19) United States
(12) Patent Application Publication
(10) Pub. No.: US 2011/0223818 A1
(43) Pub. Date: Sep. 15, 2011

(54) Bearings for Pod Propulsion System

(75) Inventors: Stig Lönngren, Kristinehamn (SE); Thore Lund, Goteborg (SE); Torbjörn Holmqvist, Lindome (SE); Pär Malmberg, Hovas (SE); Lennart Gentzel, Savedalen (SE)

(73) Assignee: ROLLSROYCE AB, Kristinehamm (SE)

(21) Appl. No.: 13/060,917

(22) PCT Filed: Aug. 27, 2009
(86) PCT No.: PCT/EP2009/006230

§ 371 Date: Apr. 29, 2011

Related U.S. Application Data
(60) Provisional application No. 61/092,397, filed on Aug. 27, 2008.

(51) Int. Cl. B63H 23/32; F16C 19/34; B63H 1/28

(52) U.S. Cl. 440/83; 384/456; 416/244 B

(57) ABSTRACT

An improved bearing assembly includes one unique shaft washer (158) rather than using separate forward and aft shaft washers as in the prior art; a slight lengthening of the forward roller (174) as compared to the aft roller (176); an increase in the diameter of the forward roller relative to the aft roller; an increase in the number of rollers; improved materials, particularly in the shaft washer (158) where fewer inclusions are present in the metal; and an osculation configured to provide less space and unconstrained movement between the rollers and runways. The improvements result in decreased movement or play between the shaft washers, the bearings/rollers, and the outer rings. The improvements and changes provide a compact design that fits within existing pod propulsion systems.

### PRIORITY CLAIM

This application claims the benefit of and priority from U.S. Provisional Patent Application No. 61/092,397 filed on Aug. 27, 2008, which is incorporated herein in its entirety for all purposes by this reference.

### FIELD

The present invention relates generally to maritime propulsion systems and, more particularly, to thrust bearing designs for pod propulsion systems designed for large vessels.

### BACKGROUND

As illustrated in FIG. 1, pod propulsion systems, or pods, 10 are often used to propel large vessels 12 such as cruise ships, naval vessels and tankers. Such pod propulsion systems 10, often called azimuthing pods, are relatively self-contained units that can be suspended beneath a ship's hull 22 and independently azimuthally rotated through 360 degrees to provide the required thrust in any direction. The azimuthing pods eliminate the need for stern tunnel thrusters and maximize maneuverability. Thus, even large vessels with azimuthing pods can maneuver into relatively small ports without the need for tug assistance. Azimuthing pods also save space, are more easily installed, and are efficient relative to conventional stern thrusters. They also provide a high degree of layout flexibility because of the relative independence of their location relative to the primary power plant of the vessel. In the case of very large vessels, the azimuthing pods are capable of generating 20 megawatts (MW) of power or more.

Pod propulsion units can be configured to include an electric motor 20 enclosed within a hydrodynamically optimized pod 10. As seen with reference to the examples in FIGS. 2-3, the electric motor 20 provides direct drive to a propeller or drive shaft 24 housed within the pod 10, thus driving a propeller 12 located outside the sealed pod 10. As the shaft 24 rotates, friction and, consequently, heat, is generated between the propeller shaft 24 and one or more bearings that support the propeller shaft 24. In addition, the torque generated at the propeller shaft 24 is transferred, in part, to the bearings. Illustrated in FIGS. 2 and 3 are two bearing assemblies, a drive end radial bearing 30 located proximate the end of the propeller shaft 24 closest to the propeller 12 and a non-drive end thrust bearing 32 spaced apart from the propeller 12 and located proximate the opposite end of the propeller shaft 24.

Bearing designs come in various configurations and designs. FIG. 4 is a cross-sectional view A-A of the bearing assembly 32 in FIG. 2. FIG. 4 illustrates a bearing assembly 50 and illustrates a conventional thrust bearing design. Such a design is often referred to as a spherical roller thrust bearing. The thrust bearing is a double row spherical roller thrust bearing with a forward roller bearing mechanism 52 and an aft roller bearing mechanism 54. The forward roller bearing mechanism 52 includes a forward inner ring, or forward shaft washer, 56 on a tapered sleeve 58 adjacent a propeller shaft 60; a forward outer ring 62 spaced apart from the forward shaft washer 56; and a plurality of forward rollers, or bearings, 64 positioned between the forward inner ring 56 and the forward outer ring 62. Similarly, the aft roller bearing mechanism 54 includes an aft inner ring, or aft shaft washer, 66 on the tapered sleeve 58; an aft outer ring 68 spaced apart from the aft shaft washer 66; and a plurality of aft rollers, or bearings, 70 positioned between the after inner ring 66 and the aft outer ring 68.

While only illustrated in cross-section, the forward and aft inner rings 56, 66 and the forward and aft outer rings 62, 68 radially surround the propeller shaft 60. The surfaces at which the forward rollers, or bearings, 64 and the forward inner and outer rings 56, 62 interact typically are referred to as raceways 72. Likewise, the surfaces at which the aft rollers, or bearings, 70 and the aft inner and outer rings 66, 68 interact typically also are referred to as raceways 72. In operation, the forward and aft inner rings 56, 66 are connected to and rotate with the propeller shaft 60. The forward and aft outer rings 62, 68, however, are not connected to the propeller shaft 60 and typically do not rotate with the propeller shaft 60. The forward and aft rollers 64, 70, thus roll or rotate between the forward and aft inner and outer rings, 56, 66, 62, and 68. Typically, the rollers or bearings 64, 70 are retained within a metal cage to keep the rollers 64, 70 in the proper alignment with respect to the forward and after inner and outer rings, 56, 66, 62, and 68.

Typically, the surfaces of the rollers, inner rings, and outer rings are provided with a slightly curved profile, called osculation. Typically, osculation is defined as the ratio of the radius of curvature of a roller to the radius of curvature of the raceway associated with the roller in a direction transverse or radial to the direction of rotation. The osculation provides a looser fit between the rollers and the raceways and, thereby, provides for the rings and rollers to stay aligned during operation. More specifically, the looser fit allows the propeller shaft to flex during rotation; expansion of the propeller shaft and the inner and outer rings caused by elastic expansion and compression under load as well as thermal expansion caused by friction; and misalignment of the propeller shaft relative to the inner and outer rings, among other benefits, without causing undue contact that might lead to internal friction, binding, and heat.

Further general details regarding spherical roller thrust bearings are provided in the brochure entitled “SKF Spherical Roller Thrust Bearings for Long Lasting Performance,” pub. 6104 EN (December 2007) available from the SKF Group of Göteborg, Sweden, which is incorporated herein by reference in its entirety.

Both axial forces/loads and radial forces/loads are placed on the propeller shaft 60 while it turns a propeller. The direction of the axial and radial loads varies depending on whether a motor coupled to the propeller shaft 60 is operating in forward or reverse. Regardless of the direction, the bearing assemblies coupled to the propeller shaft 60 are configured to bear both the axial and radial loads while the vessel is in operation and, in doing so, generate friction and consequently heat. Lubrication, such as oil, is constantly cycled through the thrust bearings or rollers and cooling systems are used to counteract the significant friction and heat generated therefrom as a load is applied to the thrust bearing assemblies. In practice, the loads placed on the pod systems on large vessels have led to significant maintenance and reliability problems for the pods and the components therein. For example, it is believed that unexpectedly high peak loads are encountered during turning or atypical maneuvering, particularly at higher speeds that place unexpectedly high axial and radial loads as well as torque on the propeller shaft and the bearing assemblies. Some of the reliability and maintenance problems include performance degradation, pitting, spalling, cracking, and outright failure of the propeller shaft, the rollers, the inner and out rings, and other components of the bearing system, despite previous efforts to engineer solutions and design components that resist such problems. The resulting surface damage then becomes the focal point for further damage during the less strenuous loads typically placed on the bearings, leading to premature failure.

Regardless of the cause of damage to the bearings, a result is that the vessels are unexpectedly removed from service for days or weeks for repairs to the pods, such as replacing and repairing prematurely worn and damaged bearing assemblies.

The previously discussed problems with prior thrust bearing assemblies have led to various attempts to provide a suitable and improved thrust bearing assembly for use in high torque pod propulsion systems. The initial response by those in the art to solve these problems focused on improved metallurgical techniques to manufacture the bearings/rollers and applying various surface coatings and treatments to the runway or merely increasing the size and number of the bearings/rollers to reduce the stress (force or load/area) that the bearings/rollers endure. These efforts, however, did not solve the problems.

Thus, there exists a need for a bearing assembly that provides for improved durability or resistance to damage caused by loads and stresses; reduced spalling, cracking and other defects; while maintaining substantially the same size of prior bearing assemblies so that the improved bearing assemblies can be easily retrofitted into existing pod propulsion systems.

### SUMMARY

Various features and embodiments of the invention disclosed herein have been the subject of substantial ongoing experimentation and have shown a significant improvement over the prior art. Among other improvements, the embodiments of the invention provide robust and durable thrust bearing assemblies that are still sufficiently compact that they may be integrated within the existing space and architecture of current pod propulsion systems. It is believed that the embodiments, collectively and/or individually, represent an unexpected advance in the field and will enable the successful scaling up of pod propulsion systems to higher power designs on larger vessels where the friction and torque on the pod propulsion systems are significantly higher than what the bearing assemblies presently encounter in current pod propulsion systems.

Embodiments of the thrust bearing assemblies disclosed herein fulfill several important functions when used with pod propulsion systems. For example, embodiments of the bearing assemblies show reductions friction and an improved transfer of axial and radial loads from the propeller shaft while the propeller shaft spins at high rates of rotation, such as 150+ rotations per minute (rpm) in the forward direction and 90+ rpm in the rearward direction as compared to the prior art. In addition, embodiments of the bearing assembly better position the propeller shaft axially and radially than the prior art.

As discussed in greater detail below, embodiments of the invention include one shaft washer rather than using separate forward and aft shaft washers as in the prior art; a slight lengthening of the forward roller as compared to the aft roller; an increase in the diameter of the forward roller relative to the aft roller; an increase in the number of rollers; improved materials, particularly in the shaft washer where fewer inclusions are present in the metal; and an osculation configured to provide less space and unconstrained movement between the rollers and runways. The improvements and changes provide for an increase in the area contact on the raceways between the bearings/rollers, the shaft washer, and the outer rings, reducing the stress caused by the axial and radial loads, while still providing a compact design that fits within existing pod propulsion systems. In addition, the collective improvements result in decreased movement or play between the shaft washers, the bearings/rollers, and the outer rings. As a result, embodiments of the invention reduce the risk of defects arising in the shaft washers, the bearings/rollers, and the outer rings, and reduce the probability that if any defects do arise they will worsen and cause significant damage.

Methods of using the above described system to detect leaks are also disclosed.

As used herein, “at least one,” “one or more,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C” and “A, B, and/or C” means A alone, B alone, C alone, A and B together, A and C together, B and C together, or A, B and C together.

Various embodiments of the present inventions are set forth in the attached figures and in the Detailed Description as provided herein and as embodied by the claims. It should be understood, however, that this Summary does not contain all of the aspects and embodiments of the one or more present inventions, is not meant to be limiting or restrictive in any manner, and that the invention(s) as disclosed herein is/are and will be understood by those of ordinary skill in the art to encompass obvious improvements and modifications thereto.

Additional advantages of the present invention will become readily apparent from the following discussion, particularly when taken together with the accompanying drawings.

### BRIEF DESCRIPTION OF THE DRAWINGS

To further clarify the above and other advantages and features of the one or more present inventions, reference to specific embodiments thereof are illustrated in the appended drawings. The drawings depict only typical embodiments and are therefore not to be considered limiting. One or more embodiments will be described and explained with additional specificity and detail through the use of the accompanying drawings in which:

FIG. 1 is an illustration of a conventional pod propulsion system;

FIG. 2 is a cutaway illustration of a conventional pod propulsion system;

FIG. 3 is another cutaway illustration of a convention pod propulsion system;

FIG. 4 is a cross-sectional view A-A of a prior art thrust bearing design illustrated in FIG. 2;

FIG. 5 illustrates an embodiment of a thrust bearing assembly for use in a pod propulsion system;

FIG. 6 illustrates another embodiment of a thrust bearing assembly for use in a pod propulsion system; and,

FIG. 7 illustrates another embodiment of a thrust bearing assembly for use in a pod propulsion system.

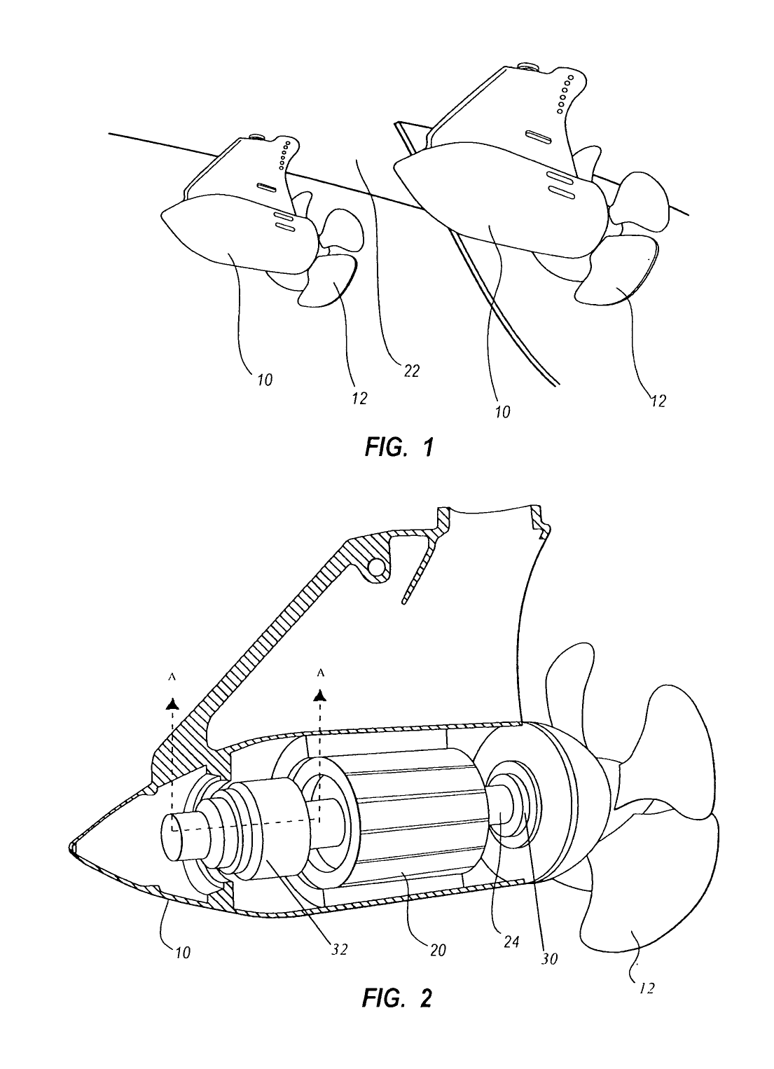

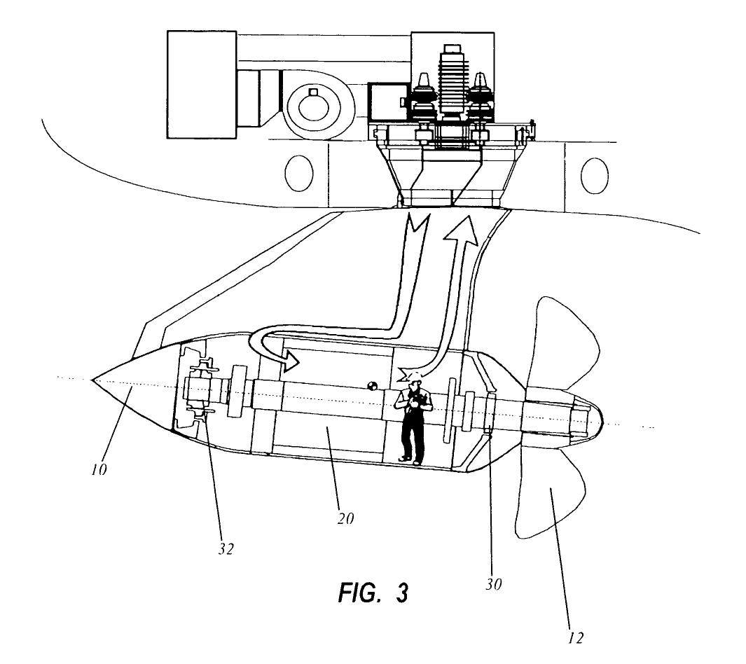

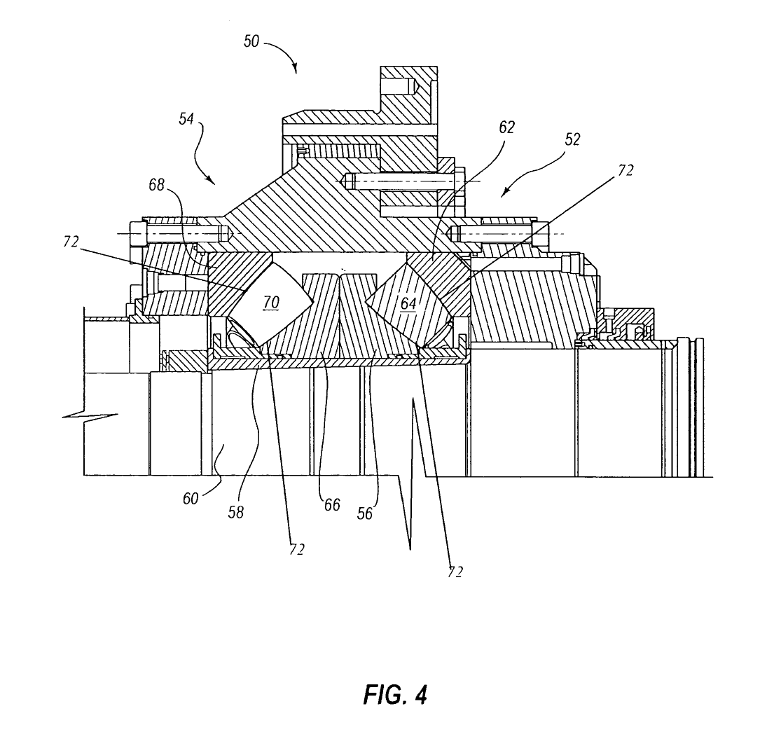

The drawings are not necessarily to scale.

### DETAILED DESCRIPTION

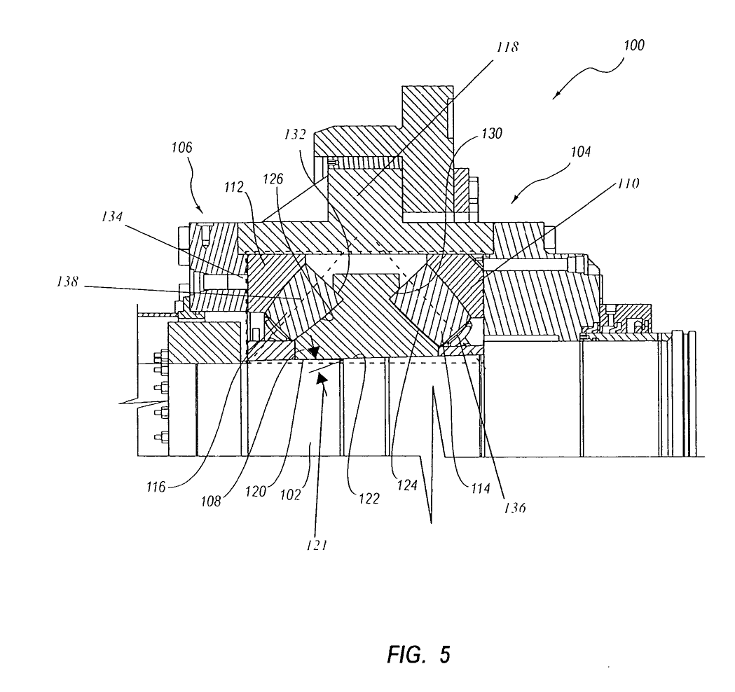

With reference now to FIG. 5, a first example embodiment of the invention is a compact high performance spherical roller thrust bearing assembly 100 for use in pod propulsion systems used with large vessels, such as large cruise ships, that are capable of generating more than 10 MW of power in operation and, more preferably, greater than 20 MW and, still more preferably, greater than 30 MW or more of power. Further details regarding pod propulsions systems can be found, for example, in the systems described hereinabove or those in U.S. Pat. No. 6,935,907 to Stig Lönngren that issued Aug. 30, 2005, which is incorporated herein by this reference in its entirety.

As illustrated in FIG. 5 the thrust bearing assembly, or just bearing assembly, 100 is positioned radially around a propeller shaft 102. The thrust bearing assembly 100 has a double row spherical roller thrust bearing design, including a forward roller bearing mechanism 104 and an aft roller bearing mechanism 106.

Unlike the design illustrated in FIG. 4 in which the forward roller bearing mechanism 52 employs a forward inner ring or forward shaft washer 56 and the aft roller bearing mechanism 54 employs a separate aft inner ring or aft shaft washer 56, the forward roller bearing mechanism 104 and the aft roller bearing mechanism 106 illustrated in FIG. 5 each interact with a single inner ring, or inner shaft washer 108. As a result, the forward roller bearing mechanism 104 and the aft roller bearing mechanism 106 are less independent from each other than the design of FIG. 4 that uses a forward and aft inner ring or shaft washer. As a result, the forward and aft bearings or rollers 114, 116 are less prone to undesired movement and the radial and axial forces/loads from the propeller shaft 102 are distributed more evenly along the forward and aft rollers 114, 116.

The use of a single shaft washer 108 represents a significant improvement, as prior to the invention it was not believed that such a fused washer was necessary or even desirable for large scale applications because it was too difficult to forge and/or manufacture such a large inner ring or shaft washer 108 of the necessary quality capable of handling the stresses, loads, and fatigue encountered in high power applications. Embodiments of the single shaft washer 108 are typically manufactured and/or forged from a high grade material, typically steel, but other types of metals fall within the scope of the disclosure, that is significantly harder and has significantly fewer inclusions than metals used in the prior art. Optionally, the same process can be used to manufacture and/or forge the forward and/or aft bearings/rollers 114, 116 as well as the forward and aft outer rings 110, 112. Embodiments of the inner shaft washer 108, the forward and/or aft bearings/rollers 114, 116, and the forward and/or aft outer rings 110, 112 that meet these requirements are available from the SKF Group of Göteborg, Sweden.

In operation, the inner shaft washer 108 rotates along a common axis of rotation with the propeller shaft 102. Unlike the embodiment of FIG. 4, however, the inner shaft washer 108 is positioned directly on the propeller shaft 102 with no intervening tapered sleeve 58 as illustrated in the conventional bearing assembly 100. A first surface 120 of the inner shaft washer 108 is configured to have a slope 121 that is adjacent to a shaft surface 122. The slope 121 typically ranges from approximately 0 degrees to about 10 degrees and, more preferably, from approximately 2.5 degrees to approximately 7.5 degrees and, more preferably still, from approximately 4 degrees to approximately 6 degrees and, most preferably, approximately 5 degrees. Configuring the inner shaft washer 108 to include a slope 121 provides a more compact and efficient design compared to conventional bearing assemblies. The inner shaft washer 108 also includes a forward raceway 124 and an aft raceway 126, where the forward bearings/rollers 114 and the aft bearings/rollers 116, respectively, interact with the shaft washer 108.

The inner shaft washer 108 incorporates a front spacer 130 configured to provide a surface upon which the forward bearing/roller 114 exerts an axial force along a long axis 136 of the forward bearing/roller 114 that occurs when the propeller shaft 102 is rotating in a direction to provide forward movement. The inner shaft washer 108 also incorporates an aft spacer 132 configured to provide a surface upon which the aft bearing/roller 116 exerts an axial force along a long axis 138 of the aft bearing/roller 116 that occurs when the propeller shaft 102 is rotating in a direction to provide rearward movement.

Each of the forward roller bearing mechanism 104 and the aft roller bearing mechanism 106 includes a forward outer ring 110 and an aft outer ring 112, respectively. A series of forward spherical bearings/rollers 114 are positioned between the shaft washer 108 and the forward outer ring 110. Similarly, a series of aft spherical bearings/rollers 116 are positioned between the shaft washer 108 and the aft outer ring 112. Metal cages, typically made from brass, steel, alloys, or other metals, are preferably used to substantially align and maintain the alignment of the forward bearings/rollers 114 and the aft bearings/rollers 116 vis-à-vis the inner shaft washer 108 and the forward and aft outer rings 110, 112, respectively.

As noted above, the forward and aft bearings/rollers 114, 116 typically have a greater length along the axis 136, 138 than those in the prior art and, optionally, the forward bearings/rollers 114 have a greater length along the axis 136 than the length of the aft bearing/roller 116 along the axis 138. In addition, the forward and aft bearings/rollers 114, 116 are typically of greater diameter than those in the prior art. As with the length, optionally the forward bearings/rollers 114 have a greater diameter than the diameter of the aft bearing/roller 116. In other words, the forward and aft bearings/rollers 114, 116 are sometimes referred to as being asymmetrical, or having a differing lengths and diameters respective to each other.

A reason for this asymmetry between the forward and aft bearings/rollers 114, 116 is that been found that during forward movement of the vessel the forward bearings/rollers 114 encounter significantly higher radial and axial forces/loads as a result of the higher rotational speed of the propeller shaft 102 as described above than those encounter by the aft bearings/rollers 116 encounters during rearward or reverse movement of the vessel. Thus, by reducing the diameter and length of the aft bearings/rollers 116, the diameter and the length of the forward bearings/rollers 114 can be increased while substantially maintaining the overall size or footprint of the prior art bearing mechanisms, allowing the use of the disclosed embodiments in present pod propulsion systems, as will be explained below.

As a result of the improvements just described, the forward and aft bearings/rollers 114, 116 have a greater contact area along the forward and aft raceways 124, 126, respectively, resulting in lower stresses imposed on the forward and aft bearings/rollers 114, 116, on the inner shaft washer 108, and the forward and aft outer rings 110, 112 for a given load during operation. For example, bearing assemblies in some prior are systems are known to have a contact surface pressure of about 1200 MPa, whereas the embodiment of FIG. 5 creates a lower contact pressure of about 1059 MPa, thereby reducing the likelihood of premature failure. Surprisingly, and as noted, this result was achieved while substantially maintaining the overall size or footprint of the prior art bearing mechanisms, allowing the use of the disclosed embodiments in present pod propulsion systems, as will be explained below.

As previously discussed, the surfaces of the forward and aft bearings/rollers 114, 116 are configured to curve or osculate with a corresponding or mating curve or osculation on the forward and aft raceways 124, 126, respectively. The curves are not configured to be an interference fit. Rather, the curves or osculations are configured to have a slight difference allows the forward and aft bearings/rollers 114, 116, the inner shaft washer 108, and the forward and aft outer rings 110, 112 to slightly flex under a load and to allow for thermal expansion caused by the heat generated from friction during operation and, thereby permitting the aforementioned elements to interact during operation without resulting in an interference fit that might cause excessive stress, friction, and heat that could lead to premature failure. Embodiments of the present invention incorporate smaller dimensional tolerances and, therefore, tighter osculation, which provides a better contact pressure optimization.

As briefly alluded to above, the forward roller bearing mechanism 104 and the aft roller bearing mechanism 106 are configured to fit within a defined space termed the envelope 134, which is generally defined in its perimeter by various part of the bearing housing 118 and the propeller shaft 102. In preferred embodiments, the design of the bearing assembly 100 permits the bearing housing 118, forward roller bearing mechanism 104, and aft roller bearing mechanism 106 to be substantially the same size of the prior art envelope despite the aforementioned improvements so they can be used in the envelope used by present bearing assemblies in currently operated pod propulsion systems. This benefit allows the simple replacement of prior bearing assemblies without having to resort to costly reengineering of the pod propulsion systems.

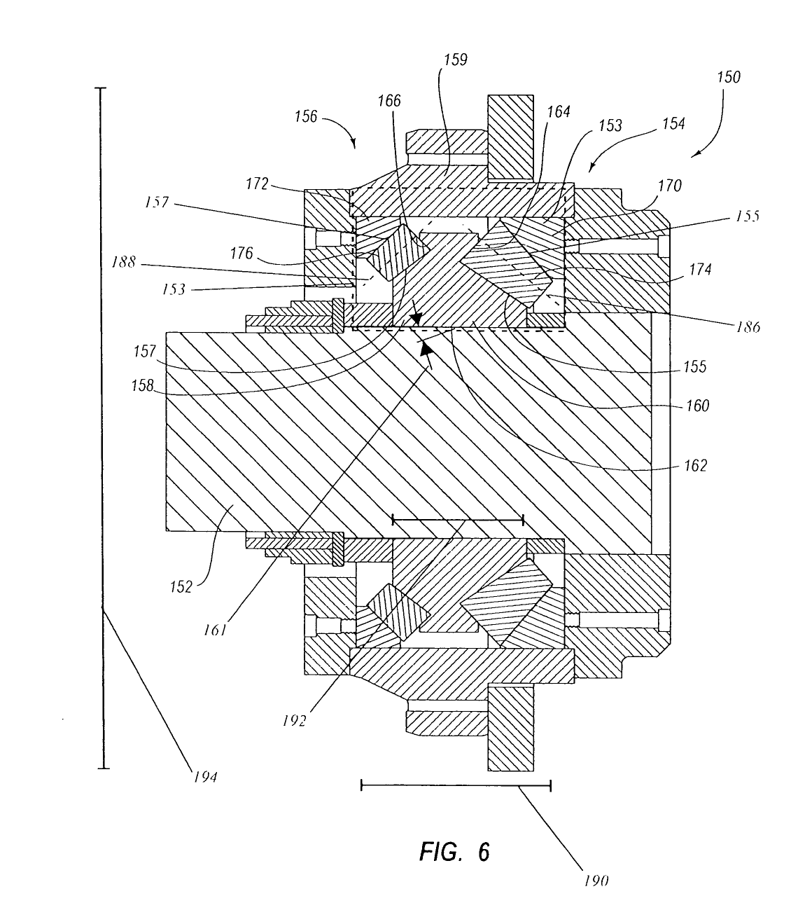

FIG. 6 illustrates another embodiment of a bearing assembly 150 believed to be particularly advantageous over the prior art when used higher power pods operating at 30 MW or more. In this embodiment the interior components of the envelope 153 have been further modified to increase the size of the forward bearings/rollers 174 relative to the forward bearings/rollers of a similar envelope size from the prior art. More particularly, the configuration of the bearing assembly 150 allows for the elongation and widening of the forward bearings/rollers 174 to reduce the stress from the axial and radial load that the propeller shaft 152 transfers to the forward bearings/rollers 174, as discussed above. And, as also noted, this change in the dimensions of the forward bearings/rollers 174 reduces the likelihood of defects forming.

As illustrated in FIG. 6, the bearing assembly 150 is positioned radially around the propeller shaft 152. The thrust bearing assembly 150 has an asymmetrical double row spherical roller thrust bearing design, including a forward roller bearing mechanism 154 and an aft roller bearing mechanism 156. Like the design illustrated in FIG. 5, the forward roller bearing mechanism 154 and the aft roller bearing mechanism 156 each interact with a single inner ring, or inner shaft washer 158. As a result, the forward roller bearing mechanism 154 and the aft roller bearing mechanism 156 are less independent from each other than the design of FIG. 4 that uses a forward and aft inner ring or shaft washer. As a result, the forward and aft bearings or rollers 174, 176 are less prone to undesired movement and the radial and axial forces/loads from the propeller shaft 152 are distributed more evenly along the forward and aft rollers 174, 176.

In operation, the inner shaft washer 158 rotates along a common axis of rotation with the propeller shaft 152. Unlike the embodiment of FIG. 4, however, the inner shaft washer 158 is positioned directly on the propeller shaft 152 with no intervening tapered sleeve 58 as illustrated in the conventional bearing assembly 100 in FIG. 4. A first surface 162 of the inner shaft washer 158 is configured to have a slope 161 that is adjacent to a shaft surface 162. The slope 161 typically ranges from approximately 0 degrees to about 10 degrees and, more preferably, from approximately 2.5 degrees to approximately 7.5 degrees and, more preferably still, from approximately 4 degrees to approximately 6 degrees and, most preferably, approximately 5 degrees. Configuring the inner shaft washer 158 to include a slope 161 provides a more compact and efficient design compared to conventional bearing assemblies. The inner shaft washer 158 also includes a forward raceway 155 and an aft raceway 157, where the forward bearings/rollers 174 and the aft bearings/rollers 176, respectively, interact with the shaft washer 158.

The inner shaft washer 158 incorporates a front spacer 164 configured to provide a surface upon which the forward bearing/roller 174 exerts an axial force along a long axis 186 of the forward bearing/roller 174 that occurs when the propeller shaft 152 is rotating in a direction to provide forward movement. The inner shaft washer 158 also incorporates an aft spacer 166 configured to provide a surface upon which the aft bearing/roller 176 exerts an axial force along a long axis 188 of the aft bearing/roller 176 that occurs when the propeller shaft 152 is rotating in a direction to provide rearward movement.

Each of the forward roller bearing mechanism 154 and the aft roller bearing mechanism 156 includes a forward outer ring 170 and an aft outer ring 172, respectively. A series of forward spherical bearings/rollers 174 are positioned between the shaft washer 158 and the forward outer ring 170. Similarly, a series of aft spherical bearings/rollers 176 are positioned between the shaft washer 158 and the aft outer ring 172. Metal cages, typically made from brass, steel, alloys, or other metals, are preferably used to substantially align and maintain the alignment of the forward bearings/rollers 174 and the aft bearings/rollers 176 vis-à-vis the inner shaft washer 158 and the forward and aft outer rings 170, 172, respectively.

As noted above, the forward and aft bearings/rollers 174, 176 typically have a greater length along the axis 186, 188 than those in the prior art and, in this embodiment, the forward bearings/rollers 174 have a greater length along the axis 186 than the length of the aft bearing/roller 176 along the axis 188. In addition, the forward and aft bearings/rollers 174, 176 are typically of greater diameter than those in the prior art. In this embodiment, the forward bearings/rollers 174 have a greater diameter than the diameter of the aft bearing/roller 176. In other words, the forward and aft bearings/rollers 174, 176 are sometimes referred to as being asymmetrical, or having a differing lengths and diameters respective to each other.

As noted, a reason for this asymmetry between the forward and aft bearings/rollers 174, 176 is that been found that during forward movement of the vessel the forward bearings/rollers 174 encounter significantly higher radial and axial forces/loads as a result of the higher rotational speed of the propeller shaft 152 as described above than those encounter by the aft bearings/rollers 176 encounters during rearward or reverse movement of the vessel. Thus, by reducing the diameter and length of the aft bearings/rollers 176, the diameter and the length of the forward bearings/rollers 174 can be increased while substantially maintaining the overall envelope 153 substantially the same as the envelope of the prior art bearing mechanisms, as discussed above.

As a result of the improvements just described, the forward and aft bearings/rollers 174, 176 have a greater contact area along the forward and aft raceways 155, 157, respectively, resulting in lower stresses imposed on the forward and aft bearings/rollers 174, 176, on the inner shaft washer 158, and the forward and aft outer rings 170, 172 for a given load during operation. For example, bearing assemblies in some prior are systems are known to have a contact surface pressure of about 1200 MPa, whereas the embodiment of FIG. 6 creates a lower contact pressure of about 953 MPa, thereby reducing the likelihood of premature failure. Surprisingly, and as noted, this result was achieved while substantially maintaining the overall size or footprint of the prior art bearing mechanisms, allowing the use of the disclosed embodiments in present pod propulsion systems, as will be explained below.

In a preferred embodiment of the bearing assembly 150, the bearing housing 159 has a length 190 of approximately 468 mm, with a length 192 of the inner shaft washer 158 of approximately 337.5 mm. Finally, the height 194 from the top to the bottom of the bearing assembly 150 in FIG. 6 is approximately 1020 mm. This preferred embodiment has a weight of approximately 1765 kg and a weight on the shaft of about 1314 kg. These weights are a consideration because it is desirable that current bearing mounting assemblies be usable for installation. If the weight (or size) went up significantly, then new mounting systems would be necessary. The compact designs of the invention avoid that necessity.

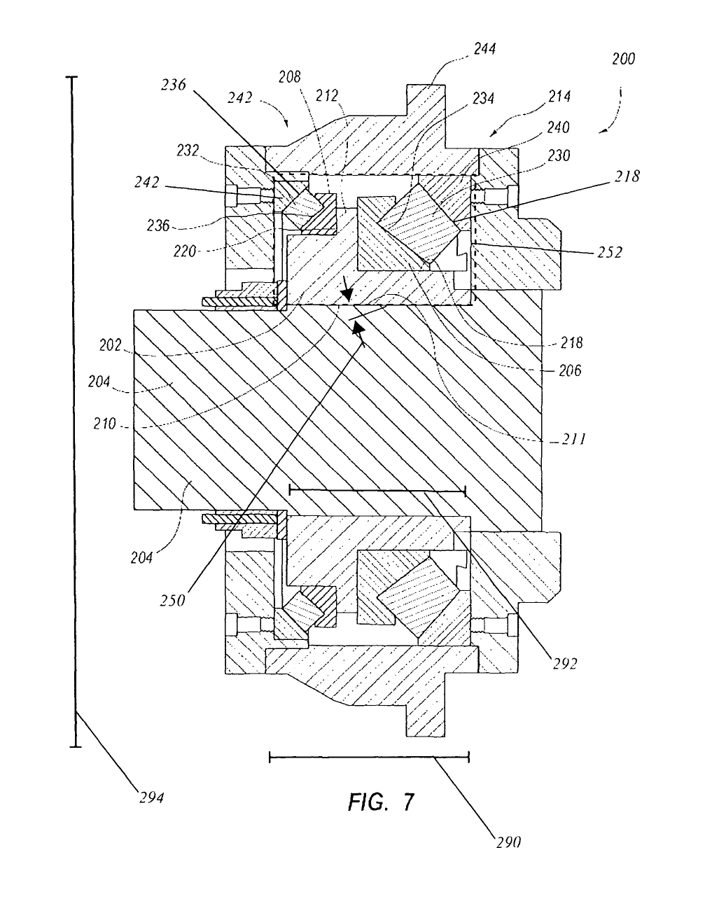

Yet another embodiment of a bearing assembly is illustrated in FIG. 7. A bearing assembly 200 is positioned radially around the propeller shaft 204. The bearing assembly 200 has an asymmetrical double row spherical roller thrust bearing design, including a forward roller bearing mechanism 214 and an aft roller bearing mechanism 242.

In operation, the inner shaft washer 202 rotates along a common axis of rotation with the shaft 204. Unlike the embodiment of FIG. 4, however, the inner shaft washer 202 is positioned directly on the propeller shaft 204 with no intervening tapered sleeve 58 as illustrated in the conventional bearing assembly 100 in FIG. 4. A first surface 211 of the inner shaft washer 202 is configured to have a slope 250 that is adjacent to a shaft surface 210. The slope 211 typically ranges from approximately 0 degrees to about 10 degrees and, more preferably, from approximately 2.5 degrees to approximately 7.5 degrees and, more preferably still, from approximately 4 degrees to approximately 6 degrees and, most preferably, approximately 5 degrees. Configuring the inner shaft washer 202 to include a slope 250 provides a more compact and efficient design compared to conventional bearing assemblies.

The shaft washer 202 also includes a dividing portion 212 configured to separate to separate a forward inner ring 206 from an aft inner ring 208. Thus, rather than use a single shaft washer 158 that serves as a the inner rings as illustrated in FIGS. 5 and 6, the bearing assembly 200 includes separate forward and aft inner rings 206, 208 within the envelope 252.

The inner shaft washer 202 also includes a forward raceway 234 and an aft raceway 236, where the forward bearings/rollers 230 and the aft bearings/rollers 232, respectively, interact with the forward inner ring 206 and the aft inner ring 208, respectively.

The bearing assembly 200 incorporates relatively larger forward bearings/rollers 230 and relatively smaller aft bearings/rollers 232 for the reasons discussed above.

Each of the forward roller bearing mechanism 214 and the aft roller bearing mechanism 242 includes a forward outer ring 240 and an aft outer ring 242, respectively. A series of forward spherical bearings/rollers 230 are positioned between the forward inner ring 206 and the forward outer ring 240. Similarly, a series of aft spherical bearings/rollers 232 are positioned between the aft inner ring 208 and the aft outer ring 242. Metal cages, typically made from brass, steel, alloys, or other metals, are preferably used to substantially align and maintain the alignment of the forward bearings/rollers 230 and the aft bearings/rollers 232 vis-à-vis the forward inner and outer rings 206, 208 and the forward and aft outer rings 170, 172, respectively.

Each of the forward and aft inner rings 206, 208; forward and aft bearings/rollers 230, 232; and forward and aft outer rings 240, 242 are configured with optimized curvatures, or osculation, and space to permit them to move and adjust under axial and radial loads so the raceways 234, 236 can maintain an optimal relationship and more even distribution of the load along the forward and aft bearings/rollers 230, 232.

As a result of the improvements just described, the forward and aft bearings/rollers 230, 232 have a greater contact area along the forward and aft raceways 234, 236, respectively, resulting in lower stresses imposed on the forward and aft bearings/rollers 230, 232; on the inner shaft washer 202; the forward and aft inner rings 206, 208; and the forward and aft outer rings 240, 242 for a given load during operation. For example, bearing assemblies in some prior are systems are known to have a contact surface pressure of about 1200 MPa, whereas the embodiment of FIG. 7 creates a lower contact pressure of about 943 MPa, thereby reducing the likelihood of premature failure. Surprisingly, and as noted, this result was achieved while substantially maintaining the overall size or footprint of the prior art bearing mechanisms, allowing the use of the disclosed embodiments in present pod propulsion systems, as will be explained below.

In a preferred embodiment of the bearing assembly 200, the bearing housing 244 has a length 290 of approximately 500 mm, with a length 292 of the inner shaft washer 202 of approximately 250 mm. Finally, the height 294 from the top to the bottom of the bearing assembly 200 in FIG. 7 is approximately 1150 mm. This preferred embodiment has a weight of approximately 2186 kg and a weight on the shaft of about 1792 kg. These weights are a consideration because it is desirable that current bearing mounting assemblies be usable for installation. If the weight (or size) went up significantly, then new mounting systems would be necessary. The compact designs of the invention avoid that necessity.

Methods of forming and/or manufacturing the embodiments of the disclosed bearing assemblies fall within the scope of the invention. While one having skill in the art would understand from the disclosure above the methods involved, it will be understood that the methods include at least providing a plurality of forward bearings configured to support a first axial force and a first radial force. The methods further include providing a plurality of aft bearings configured to support a second axial force and a second radial force, as well as providing an providing an inner shaft washer coupled to a propeller shaft, the inner shaft washer configured to transfer the first axial force and the first radial force to the plurality of forward bearings when the propeller shaft rotates in a forward direction and to transfer the second axial force and the second radial force to the plurality of aft bearings when the propeller shaft rotates in a rearward direction.

The present invention, in various embodiments, includes providing devices and processes in the absence of items not depicted and/or described herein or in various embodiments hereof, including in the absence of such items as may have been used in previous devices or processes, e.g., for improving performance, achieving ease and/or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A bearing assembly configured to support a propeller shaft comprising:
a plurality of forward bearings configured to support a first axial force and a first radial force;
a plurality of aft bearings configured to support a second axial force and a second radial force;
an inner shaft washer coupled to said propeller shaft, said inner shaft washer configured to transfer said first axial force and said first radial force to said plurality of forward bearings when said propeller shaft rotates in a forward direction and to transfer said second axial force and said second radial force to said plurality of aft bearings when said propeller shaft rotates in a rearward direction.

2. The bearing assembly of claim 1, wherein each of said plurality of forward bearings having a first length, each of said plurality of aft bearings having a second length, and wherein said first length is greater than said second length.

3. The bearing assembly of claim 1, wherein each of said plurality of forward bearings having a first diameter, each of said plurality of aft bearings having a second diameter, and wherein said first diameter is greater than said second diameter.

4. The bearing assembly of claim 1, wherein said bearing assembly further comprises:
a forward inner ring interposed between said inner shaft washer and said plurality of forward bearings, said forward inner ring configured to transfer said first axial force and said first radial force to said plurality of forward bearings from said inner shaft washer.

5. The bearing assembly of claim 4, wherein said bearing assembly further comprises:
an aft inner ring interposed between said inner shaft washer and said plurality of aft bearings, said aft inner ring configured to transfer said second axial force and said radial force to said plurality of aft bearings from said inner shaft washer.

6. The bearing assembly of claim 4, further comprising a forward outer ring spaced apart from said forward inner ring with said plurality of forward bearings interposed therebetween.

7. The bearing assembly of claim 5, further comprising an aft outer ring spaced apart from said aft inner ring with said plurality of aft bearings interposed therebetween.

8. A pod propulsion system comprising:
a motor configured to provide a rotational force to a propeller shaft;
a bearing assembly configured to support a propeller shaft, said bearing assembly including bearing housing configured to hold therein:
a plurality of forward bearings configured to support a first axial force and a first radial force;
a plurality of aft bearings configured to support a second axial force and a second radial force;
an inner shaft washer coupled to said propeller shaft, said inner shaft washer configured to transfer said first axial force and said first radial force to said plurality of forward bearings when said propeller shaft rotates in a forward direction and to transfer said second axial force and said second radial force to said plurality of aft bearings when said propeller shaft rotates in a rearward direction.

9. The bearing assembly of claim 8, wherein said bearing assembly further comprises:
a forward inner ring interposed between said inner shaft washer and said plurality of forward bearings, said forward inner ring configured to transfer said first axial force and said first radial force to said plurality of forward bearings from said inner shaft washer.

10. The bearing assembly of claim 8, wherein said bearing assembly further comprises:
an aft inner ring interposed between said inner shaft washer and said plurality of aft bearings, said aft inner ring configured to transfer said second axial force and said radial force to said plurality of aft bearings from said inner shaft washer.

11. The bearing assembly of claim 9, further comprising a forward outer ring spaced apart from said forward inner ring with said plurality of forward bearings interposed therebetween.

12. The bearing assembly of claim 10, further comprising an aft outer ring spaced apart from said aft inner ring with said plurality of aft bearings interposed therebetween.

13. A method of supporting a propeller shaft in a marine propulsion system comprising:
providing a plurality of forward bearings configured to support a first axial force and a first radial force;
providing a plurality of aft bearings configured to support a second axial force and a second radial force;
providing an inner shaft washer coupled to said propeller shaft, said inner shaft washer configured to transfer said first axial force and said first radial force to said plurality of forward bearings when said propeller shaft rotates in a forward direction and to transfer said second axial force and said second radial force to said plurality of aft bearings when said propeller shaft rotates in a rearward direction.

14. The method of claim 13, wherein said method further comprises:
providing a forward inner ring interposed between said inner shaft washer and said plurality of forward bearings, said forward inner ring configured to transfer said first axial force and said first radial force to said plurality of forward bearings from said inner shaft washer.

15. The method of claim 13, wherein said method further comprises:
providing an aft inner ring interposed between said inner shaft washer and said plurality of aft bearings, said aft inner ring configured to transfer said second axial force and said radial force to said plurality of aft bearings from said inner shaft washer.

16. The method of claim 14, wherein said method further comprises providing a forward outer ring spaced apart from said forward inner ring with said plurality of forward bearings interposed therebetween.

17. The bearing assembly of claim 15, wherein said method further comprises providing an aft outer ring spaced apart from said aft inner ring with said plurality of aft bearings interposed therebetween.
